(19) United States
(12) Patent Application Publication
(10) Pub. No.: US 2014/0174615 A1
(43) Pub. Date: Jun. 26, 2014

(54) TBR Based Implement Tire

(71) Applicant: BRIDGESTONE AMERICAS TIRE OPERATIONS, LLC, Nashville, TN (US)

(72) Inventor: Bradley J. Harris, New London, OH (US)

(73) Assignee: BRIDGESTONE AMERICAS TIRE OPERATIONS, LLC, Nashville, TN (US)

(21) Appl. No.: 13/723,254

(22) Filed: Dec. 21, 2012

(51) Int. Cl. B60C 5/00

(52) U.S. Cl. CPC B60C 5/00
USPC 152/209.1; 156/110.1

(57) ABSTRACT

A VF rated radial implement tire is provided utilizing a steel belted radial TBR tire body design which can be utilized in existing TBR cavity molds, and modifying the tire to have a ribbed implement tread pattern. The tire is designed for operation at relatively low inflation pressures with relatively high wall flexibility. Thus an agricultural implement tire is provided having higher load carrying capability than similarly sized conventional bias ply agricultural implement tires.

### BACKGROUND OF THE INVENTION

1. Field of the Invention

The present invention relates to pneumatic tires, and more particularly to tires for use on non self propelled agricultural implements.

2. Description of the Prior Art

Conventional construction for free rolling farm implement tires has typically been of the bias ply construction utilizing a ribbed implement tread.

Also, in some instances where a heavier load carrying capacity has been needed, farmers have utilized tires originally intended for highway use on trucks and buses, commonly referred to as TBR tires, which have a radial steel reinforced body ply and steel belt construction utilizing conventional highway type tread patterns. These TBR tires have been placed in free rolling use on farm implements, and have been used at rated inflation pressures.

There is a continuing need for improvement in agricultural implement tires, particularly as tires are required to carry ever heavier loads and to function at higher speeds when in transit mode.

### SUMMARY OF THE INVENTION

In one aspect a pneumatic agricultural implement tire includes a circumferential tread portion including a ribbed implement tread pattern having a plurality of relatively wide parallel circumferential ribs separated by relatively narrow circumferential grooves. The tire includes a pair of bead portions, and a steel reinforced radial carcass ply extending between and wrapped around the bead portions. The tire includes at least three steel reinforced circumferentially extending belts disposed between the carcass ply and the circumferential tread portion. The tire is sized to fit on one of a nominal 19.5 inch or 22.5 inch or 24.5 inch diameter rim. The tire is constructed to have a sidewall deflection at rated load and inflation pressure of at least about 27%. The tire has a VF load rating in accordance with the standards of the Tire and Rim Association.

In another aspect a pneumatic agricultural implement tire includes a tire body of TBR construction including at least one steel reinforced body ply and at least three circumferential steel reinforced belts, the body being constructed to fit on one of a nominal 19.5 inch or 22.5 inch or 24.5 inch diameter rim. The tire includes a tread portion on the tire body. The tread portion includes a ribbed implement tread pattern. The tire has a maximum load rating at a maximum inflation pressure resulting in a sidewall deflection of at least 27%.

In another embodiment a method is provided for manufacturing a pneumatic agricultural implement tire. The method includes providing a tire body of TBR construction including at least one steel reinforced body ply and at least three circumferential steel reinforced belts. The tire body is constructed to fit on one of a nominal 19.5 inch or 22.5 inch or 24.5 inch diameter rim. A tread portion is provided on the tire body, the tread portion including a ribbed implement tread pattern. The tire is constructed to have a maximum load rating at a maximum inflation pressure resulting in a sidewall deflection of at least about 27%.

Numerous objects, features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a schematic plan view of a farm implement, in this case a wing fold type seed planter being drawn by a tractor.

FIG. 2 is a schematic rear elevation view of the farm implement of FIG. 1 showing the wing portions of the planter in operational mode in solid lines, and folded up into transport mode in dashed lines.

FIG. 3 is a cross-sectional view of one embodiment of a tire of the present invention.

FIG. 4 is a laid out view of the tread portion of the tire.

### DETAILED DESCRIPTION OF THE INVENTION

Following are definitions of selected terms employed herein. The definitions include various examples and/or forms of components that fall within the scope of a term and that may be used for implementation. The examples are not intended to be limiting. Both singular and plural forms of terms may be within the definitions.

“Aspect ratio” means the ratio of the tire's section height to its section width.

“Axial” and “axially” refer to directions which are parallel to the axis of rotation of a tire.

“Bead” or “bead core” refers to that part of a tire comprising an annular tensile member, the bead core, wrapped by ply cords and shaped, with or without other reinforcement elements to fit a designed tire rim.

“Belt” or “belt ply” refers to an annular layer or ply of parallel cords, woven or unwoven, underlying the tread, not anchored to the bead.

“Carcass” refers to the tire structure apart from the belt structure, tread, undertread, and sidewall rubber but including the beads, (carcass plies are wrapped around the beads).

“Circumferential” refers to lines or directions extending along the perimeter of the surface of the annular tread perpendicular to the axial direction.

“Cord” means one of the reinforcement strands of which the plies in the tire are comprised.

“Crown” refers to substantially the outer circumference of a tire where the tread is disposed.

“Equatorial plane (EP)” refers to a plane that is perpendicular to the axis of rotation of a tire and passes through the center of the tire's tread.

“Inner liner” means the layer or layers of elastomer or other material that form the inside surface of a tubeless tire and that contain the inflating fluid within the tire.

“Nominal rim diameter” means the average diameter of the rim flange at the location where the bead portion of the tire seats.

“Ply” means a continuous layer of rubber coated parallel cords.

“Radial” and “radially” refer to directions that are perpendicular to the axis of rotation of a tire.

“Radial-ply” or “radial-ply tire” refers to a belted or circumferentially-restricted pneumatic tire in which the ply cords which extend from bead to bead are laid at cord angles between 65 degree and 90 degree with respect to the equatorial plane of the tire.

“Section height” (SH) means the radial distance from the base of the bead core to the outer diameter of the tire at its equatorial plane.

“Section width” (SW) means the maximum linear distance parallel to the axis of the tire and between the exterior of its sidewalls when and after it has been inflated at normal inflation pressure for 24 hours, but unloaded, excluding elevations of the sidewalls due to labeling, decoration or protective bands.

“Turn-up height” (TH) means the radial distance from the base of the bead core to the upper end of the turn-up.

Directions are also stated in this application with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” are used in connection with an element, the “upper” element is spaced closer to the tread than the “lower” element. Additionally, when relative directional terms such as “above” or “below” are used in connection with an element, an element that is “above” another element is closer to the tread than the other element. The terms “axially inward” and “axially inwardly” refer to a general direction towards the equatorial plane of the tire, whereas “axially outward” and “axially outwardly” refer to a general direction away from the equatorial plane of the tire and towards the sidewall of the tire.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

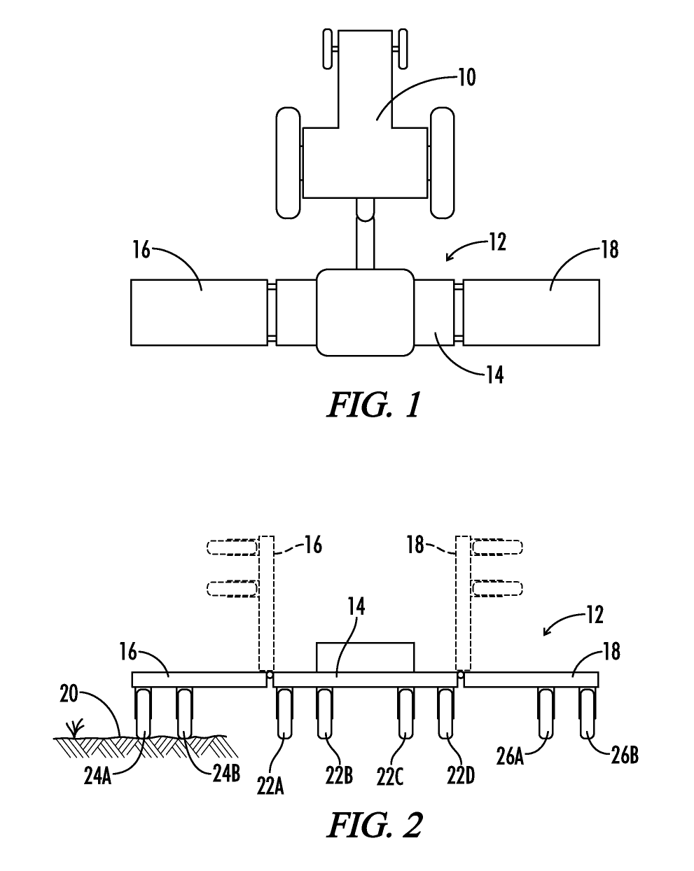

In FIG. 1, a schematic plan view is shown of a tractor 10 pulling a free wheeled agricultural implement which in the case illustrated is a wing fold type seed planter 12. The seed planter 12 includes a center portion 14 and left and right wing portions 16 and 18.

As seen in FIG. 2, the center portion 14 and the wing portions 16 and 18 are each supported from the ground surface 20 by a plurality of pneumatic tires mounted on wheel rims. In the illustration of FIG. 2, the center portion 14 is carried by four center portion tires 22A, 22B, 22C and 22D. The wing portion 16 is carried on two wing portion tires 24A and 24B and the wing portion 18 is carried on two wing portion tires 26A and 26B.

When the planter 12 is to be transported along the public highways from one field to another, the wing portions 16 and 18 may fold up into the position shown in phantom lines in FIG. 2. Thus, in the transport mode, the center portion wheels 22A-22D must carry the total combined weight of the planter 12. Thus, the center portion wheels 22A-22D are typically of larger and heavier construction than are the wing portion wheels 24A and 24B and 26A and 26B.

In one embodiment, the pneumatic agricultural implement tires of the present invention are particularly suitable for use as the center portion tires 22A-22D of a fold up seed planter such as shown in FIG. 2. In general the tires of the present invention are suitable for use on many different types of free wheeling agricultural implements including corn planters, tillage equipment, disc implements, rippers, field cultivators, air seeders and the like.

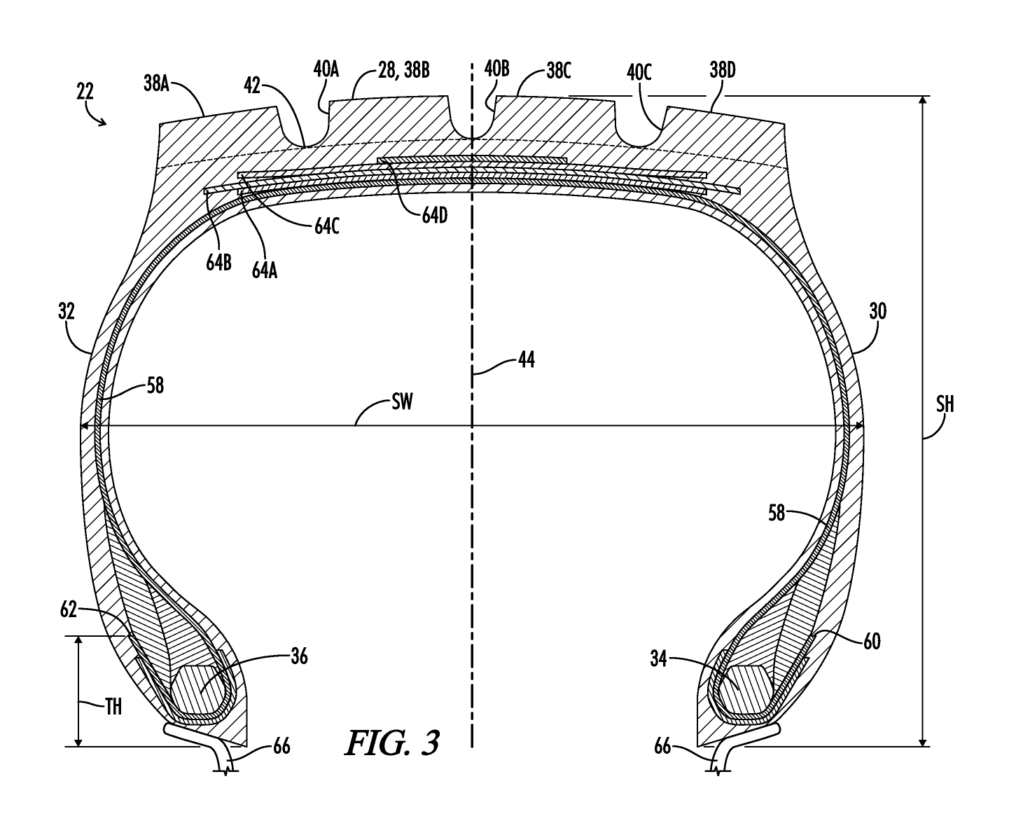

In FIG. 3 a cross-sectional view is shown of one of the tires 22. The tire 22 includes a circumferential tread or tread portion 28, first and second sidewalls or sidewall portions 30 and 32, and first and second beads or bead portions 34 and 36. Each of the bead portions comprises a bundle of bead wires.

The circumferential tread portion 28 includes a ribbed implement tread pattern having a plurality of relatively wide parallel circumferential ribs 38A-38D separated by relatively narrow circumferential grooves 40A-40C. The ribs 38 extend upward from a tread floor 42. The tire has a section width SW, a section height SH, and a turn-up height TH.

The tire includes one or more carcass plies 58. In the embodiment illustrated there is one and only one carcass ply 58, which is preferably a steel reinforced radial carcass ply 58. The carcass ply 58 extends circumferentially about the tire, and includes an axially inner portion and axially outer portions that extend around the bead portions and extend upwardly toward the tread portion and terminate at turn-up ends 60 and 62.

A plurality of circumferentially extending belts 64 are disposed between the carcass ply 58 and the tread portion 28. In the embodiment illustrated there are four such belts 64A, 64B, 64C and 64D. The belts 64A-64D are preferably steel reinforced belts, and alternating belts may have the reinforcing cords thereof biased at alternating angles.

In general the belt package 64 may be described as including at least three steel reinforced belts. The belt package may also be described as including three or four steel reinforced belts.

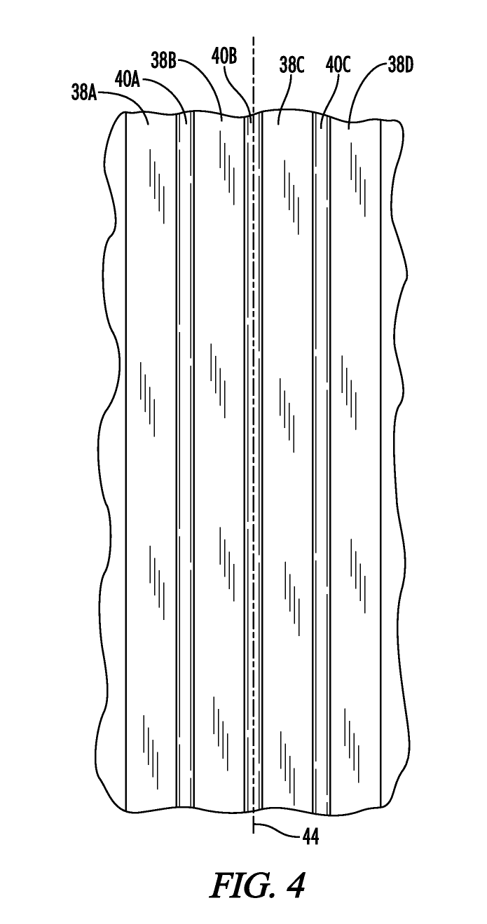

A suitable design for the carcass or body portion of the tire 22 may be achieved by utilizing an existing carcass designed for a traditional TBR tire intended for highway use on trucks and buses. This also allows existing TBR mold cavities to be utilized. The molds need only be modified in that the tread portion dies must be changed to form a ribbed implement tread pattern like that of FIGS. 3 and 4, rather than the traditional TBR highway use tread patterns.

In order to reduce the damage to fields caused by the tires, the tires should be constructed to operate at relatively lower inflation pressures, in the range of from about 40 psi to about 65 psi, which are much lower than the typical 100 psi to 120 psi operating inflation pressures for TBR tires designed for highway usage. This requires the tires to operate with a sidewall deflection at their rated load and inflation pressure greater than the deflections typically encountered with TBR tires designed for highway usage.

The tires 22 should be constructed so as to operate satisfactorily with a sidewall deflection at a rated load and inflation pressure of at least about 27%, and more particularly in a range of from about 27% to about 32%. That is contrasted to the sidewall deflections encountered in typical TBR tires constructed for highway use which is typically in the range of 18 to 19%.

The sidewall deflection percentage is measured by comparing the section height SH of the tire at zero load, to the section height of the tire at rated load. The deflection percentage is the percentage decrease in section height at rated load.

The design approach described above is particularly suited for use on tire rims 66 having a nominal diameter of 19.5 inch or 22.5 inch, which are readily available for use on agricultural implements. The TBR based implement tire construction described herein may also be applied to tires designed for use on a nominal 24.5 inch diameter rim.

The tire construction described above provides a basis for construction of a tire to achieve a VF load rating for a radial implement tire. A VF load rating is defined in the 2012 Year Book published by the Tire and Rim Association, Inc. as “VF—Identifies an agricultural tire to operate at 40% higher rated load than statndard metric tires at the same inflation pressure.”

The following Table I summarizes four examples of new tire sizes of the pneumatic agricultural implement tire 22 described above. The first column labeled “New Tire Size” describes the size of the four examples of the present invention. The second column labeled “New Rated Load @ Pressure” gives the rated load carrying capability of the new tire and identifies the pressure at which that rating is given. The third column labeled “Sidewall Deflection @ Load” states the percentage of sidewall deflection of the new tire when subjected to its rated load. The fourth column labeled “Old Tire Replaced” identifies a similar size prior art tire which could be replaced by the new tire. The fifth column labeled “Old Rated Load @ Pressure” gives the rated loading for the old tire.

TABLE I

| | New Rated | Sidewall | | Old Rated |
|---|---|---|---|---|
| New Tire | Load@ | Deflection @ | Old Tire | Load @ |
| Size | Pressure | Load | Replaced | Pressure |
| VF | 4680 Lb @ | 30.7% | 245/70R19.5 | 4540 Lb @ |
| 245/70R19.5 | 58 psi | | TBR tire | 110 psi |
| VF | 6400 Lb @ | 29.7% | 295/75R22.5 | 6175 Lb @ |
| 295/75R22.5 | 52 psi | | TBR tire | 110 psi |
| VF | 9350 Lb @ | Not | 14L-16.1 | 5200 Lb @ |
| 385/65R22.5 | 58 psi | available | | 52 psi |
| VF | 12,800 Lb @ | Not | 19L-16.1 | 6600 Lb @ |
| 445/65R22.5 | 64 psi | available | | 36 psi |

Thus, the first example is a tire of size VF 245170R19.5 which is rated for a load of at least 4680 pounds at a cold inflation pressure of 58 psi. The tire has a sidewall deflection at load of 30.7%. It is suitable for replacement of a 245/70R19.5 TBR type tire which is rated for a load of 4540 pounds at a cold inflation pressure of 110 psi.

It is noted that in the first and second examples in the table, the most commonly used prior art tire which would be replaced by this tire is a similarly sized TBR tire designed for highway usage.

Because the tires 22 are designed for use at relatively low inflation pressures with relatively high wall flexibility, they are not suitable for highway usage on trucks and buses, and thus preferably their sidewalls are permanently marked with an indicia indicating that the tire is not for highway service. This is to avoid a user mistakenly placing the tire on a truck or bus being operated at highway speeds.

Thus it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A pneumatic agricultural implement tire, comprising:
a circumferential tread portion including a ribbed implement tread pattern having a plurality of relatively wide parallel circumferential ribs separated by relatively narrow circumferential grooves;
a pair of bead portions;
a steel reinforced radial carcass ply extending between and wrapped around the bead portions;
at least three steel reinforced circumferentially extending belts disposed between the carcass ply and the circumferential tread portion;
the tire being sized to fit on one of a nominal 19.5 inch or 22.5 inch or 24.5 inch diameter rim;
the tire having a sidewall deflection at rated load and inflation pressure of at least about 27%; and
the tire having a VF load rating in accordance with the standards of the Tire and Rim Association.

2. The tire of claim 1, wherein:
the sidewall deflection at rated load and inflation pressure is less than about 32%.

3. The tire of claim 1, wherein:
the tire is a size VF 245/70R19.5 and is rated for a load of at least about 4680 pounds at a cold inflation pressure of 58 psi.

4. The tire of claim 1, wherein:
the tire is a size VF 295/75R22.5 and is rated for a load of at least about 6400 pounds at a cold inflation pressure of 52 psi.

5. The tire of claim 1, wherein:
the tire is a size VF 385/65R22.5 and is rated for a load of at least about 9350 pounds at a cold inflation pressure of 58 psi.

6. The tire of claim 1, wherein:
the tire is a size VF 445/65R22.5 and is rated for a load of at least about 12,800 pounds at a cold inflation pressure of 64 psi.

7. The tire of claim 1, wherein:
the tire is permanently marked with an exterior indicia stating that the tire is not for highway service.

8. The tire of claim 1, wherein:
the tire has one and only one steel reinforced carcass ply.

9. The tire of claim 1, wherein:
the at least three belts comprise no more than four belts.

10. A pneumatic agricultural implement tire, comprising:
a tire body of TBR construction including at least one steel reinforced body ply and at least three circumferential steel reinforced belts, the tire body being constructed to fit on one of a nominal 19.5 inch or 22.5 inch or 24.5 inch diameter rim;
a tread portion on the tire body, the tread portion including a ribbed implement tread pattern; and
the tire having a maximum load rating at a maximum inflation pressure resulting in a sidewall deflection of at least about 27%.

11. The tire of claim 10, wherein the sidewall deflection is less than about 32%.

12. The tire of claim 10, wherein:
the tire is a size VF 245/70R19.5 and is rated for a load of at least about 4680 pounds at a cold inflation pressure of 58 psi.

13. The tire of claim 10, wherein:
the tire is a size VF 295/75R22.5 and is rated for a load of at least about 6400 pounds at a cold inflation pressure of 52 psi.

14. The tire of claim 10, wherein:
the tire is a size VF 385/65R22.5 and is rated for a load of at least about 9350 pounds at a cold inflation pressure of 58 psi.

15. The tire of claim 10, wherein:
the tire is a size VF 445/65R22.5 and is rated for a load of at least about 12,800 pounds at a cold inflation pressure of 64 psi.

16. The tire of claim 10, wherein:
the tire is permanently marked with an exterior indicia stating that the tire is not for highway service.

17. The tire of claim 10, wherein:
the tire has one and only one steel reinforced body ply.

18. The tire of claim 10, wherein:
the at least three belts comprise no more than four belts.

19. The tire of claim 10, wherein:
the tire has a VF load rating in accordance with the standards of the Tire and Rim Association.

20. A method of manufacturing a pneumatic agricultural implement tire, the method comprising:
providing a tire body of TBR construction including at least one steel reinforced body ply and at least three circumferential steel reinforced belts, the tire body being constructed to fit on one of a nominal 19.5 inch or 22.5 inch or 24.5 inch diameter rim;
providing a tread portion on the tire body, the tread portion including a ribbed implement tread pattern; and
constructing the tire to have a maximum load rating at a maximum inflation pressure resulting in a sidewall deflection of at least about 27%.

21. The method of claim 20, wherein the sidewall deflection is less than about 32%.

22. The method of claim 20, wherein:
the constructing step further comprises constructing the tire to have a VF load rating in accordance with the standards of the Tire and Rim Association.
